(19) United States
(12) Patent Application Publication
(10) Pub. No.: US 2024/0338626 A1
(43) Pub. Date: Oct. 10, 2024

(54) TIMED PARTIAL ORDER IDENTIFICATION FOR TASK LEARNING FROM DATA

(71) Applicant: Toyota Motor Engineering & Manufacturing North America, Inc., Plano, TX (US)

(72) Inventors: Kandai Watanabe, Boulder, CO (US); Bardh Hoxha, Canton, MI (US); Georgios Fainekos, Novi, MI (US); Tomoya Yamaguchi, Plano, TX (US); Danil Prokhorov, Canton, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/297,481

(22) Filed: Apr. 7, 2023

(51) Int. Cl. G06Q 10/0633

(52) U.S. Cl. CPC G06Q 10/0633

(57) ABSTRACT

A system is provided for use with a plurality of timed traces for performing a task. The system includes: a data receiver configured to receive the plurality of timed traces; a memory having instructions stored therein; and a processor configured to execute the instructions stored in the memory to cause the system to: store the received plurality of timed traces into the memory; generate a partial order graph of time constraints between all of the plurality of timed traces; generate a transitive reduced partial order graph from the partial order graph, the transitive reduced partial order graph not including redundant time constraints within the partial order graph; and generate a timed partial order graph from the transitive reduced partial order graph, the timed partial order graph having a minimum number of clocks required to explain the time constraints between all of the plurality of timed traces.

### TECHNICAL FIELD

One or more embodiments relate generally to systems and methods for modeling workflows.

### BACKGROUND

Workflows appear in diverse areas, including business processes, software engineering, and factory pipelines. The individual events in a workflow, such as the start/end of a particular task or the achievement of an intermediate subgoal, are ordered according to a strict partial order that specifies that some event eᵢ always happens before another event eⱼ. Such partial orders have been used to represent plans in classic AI planning algorithms. Beyond partial orders, there are often timing constraints between events in a workflow that place bounds on the time when an individual event occurs or the time elapsed between two events in the workflow.

Learning a task from log data is known as Workflow Mining or Process Mining. Most approaches to process mining focus on modeling the order in which tasks are performed, but do not capture timing constraints. As such, process mining has been widely used in the manufacturing time study industry. It is supported by commercial tools such as Disco, Celonis, and Process Gold; and open source tools such as ProM, Apromore and pm4py. Under the hood, these tools implement algorithms such as the α− algorithm that outputs a Petri Net, α+ algorithm that can handle loops, and an algorithm that can handle duplicate events. Various types of α− algorithm were introduced to overcome some of its limitations. Other approaches are also introduced such as region-based approaches that can express more complex control-flow structures and heuristic mining, fuzzy mining, query-based mining that can handle incomplete data and genetic process mining that can handle noise. Some also focus on inferring “typical transition time” between two events by counting the number of steps between them.

On the other hand, researchers have extended automata learning techniques to learn timed automata that can capture timing constraints. For instance, some have extended Evidence-Driven State Merging (EDSM)-based algorithms to learn from data with timestamps and estimate a real-time timed automaton whose edges are labeled with time duration. Although the algorithm is fast, it can only infer inexpressive time constraints. Some have also extended a L*-based approach, and others have formulated the problem such that it can be solved by Satisfiability Modulo Theories (SMT). However, the former assumes a perfect oracle, and the latter is correct but very slow due to the nature of the SMT solver which often leads to exponential time. A genetic algorithm-based approach is fast and gives a good solution if it finds one, but has no optimal guarantees. All these approaches can estimate some types of Timed Automata, which are very expressive models, but all, as noted above, have different disadvantages.

### SUMMARY

An aspect of the present disclosure is drawn to a system for use with a plurality of timed traces for performing a task, wherein each of the plurality of timed traces includes a respective event data and a respective time data. In this aspect, the system includes: a data receiver configured to receive the plurality of timed traces; a memory having instructions stored therein; and a processor configured to execute the instructions stored in the memory to cause the system to: store the received plurality of timed traces into the memory; generate a partial order graph of time constraints between all of the plurality of timed traces; generate a transitive reduced partial order graph from the partial order graph, the transitive reduced partial order graph not including redundant time constraints within the partial order graph; and generate a timed partial order graph from the transitive reduced partial order graph, the timed partial order graph having a minimum number of clocks required to explain the time constraints between all of the plurality of timed traces.

In some embodiments of this aspect, the system further includes a display configured to display the timed partial order graph.

In some embodiments of this aspect, the system further includes: a user interface configured to enable a user to add a new timed trace to the plurality of timed traces, wherein the processor is configured to execute the instructions stored in the memory to additionally cause the system to: generate an updated partial order graph of updated time constraints between all of the plurality of timed traces and the new timed trace; generate an updated transitive reduced partial order graph from the updated partial order graph, the updated transitive reduced partial order graph not including redundant time constraints within the updated partial order graph; and generate an updated timed partial order graph from the updated transitive reduced partial order graph, the updated timed partial order graph having an updated minimum number of clocks required to explain the time constraints between all of the plurality of timed traces and the new timed trace.

In some embodiments of this aspect, the system further includes: a user interface configured to enable a user to modify a timed trace of the plurality of timed traces, wherein the processor is configured to execute the instructions stored in the memory to additionally cause the system to: generate an updated partial order graph of updated time constraints between all of the plurality of timed traces including the modified timed trace; generate an updated transitive reduced partial order graph from the updated partial order graph, the updated transitive reduced partial order graph not including redundant time constraints within the updated partial order graph; and generate an updated timed partial order graph from the updated transitive reduced partial order graph, the updated timed partial order graph having an updated minimum number of clocks required to explain the time constraints between all of the plurality of timed traces including the modified timed trace.

Another aspect of the present disclosure is drawn to a method of using a plurality of timed traces for performing a task, wherein each of the plurality of timed traces includes a respective event data and a respective time data. In this aspect, the method includes: receiving, via a data receiver, the plurality of timed traces; storing, via a processor configured to execute instructions stored in a memory, the received plurality of timed traces into the memory; generating, via the processor, a partial order graph of time constraints between all of the plurality of timed traces; generating, via the processor, a transitive reduced partial order graph from the partial order graph, the transitive reduced partial order graph not including redundant time constraints within the partial order graph; and generating, via the processor, a timed partial order graph from the transitive reduced partial order graph, the timed partial order graph having a minimum number of clocks required to explain the time constraints between all of the plurality of timed traces.

In some embodiments of this aspect, the method further comprises displaying, via a display, the timed partial order graph.

In some embodiments of this aspect, the method further comprises: adding, via a user interface, a new timed trace to the plurality of timed traces; generating, via the processor, an updated partial order graph of updated time constraints between all of the plurality of timed traces and the new timed trace; generating, via the processor, an updated transitive reduced partial order graph from the updated partial order graph, the updated transitive reduced partial order graph not including redundant time constraints within the updated partial order graph; and generating, via the processor, an updated timed partial order graph from the updated transitive reduced partial order graph, the updated timed partial order graph having an updated minimum number of clocks required to explain the time constraints between all of the plurality of timed traces and the new timed trace.

In some embodiments of this aspect, the method further comprises: modifying, via a user interface, a timed trace of the plurality of timed traces, generating, via the processor, an updated partial order graph of updated time constraints between all of the plurality of timed traces including the modified timed trace; generating, via the processor, an updated transitive reduced partial order graph from the updated partial order graph, the updated transitive reduced partial order graph not including redundant time constraints within the updated partial order graph; and generating, via the processor, an updated timed partial order graph from the updated transitive reduced partial order graph, the updated timed partial order graph having an updated minimum number of clocks required to explain the time constraints between all of the plurality of timed traces including the modified timed trace.

Another aspect of the present disclosure is drawn to a non-transitory, computer-readable media having computer-readable instructions stored thereon, wherein the computer-readable instructions is capable of being read by a system for use with a plurality of timed traces for performing a task, wherein each of the plurality of timed traces includes a respective event data and a respective time data, and wherein the computer-readable instructions are capable of instructing the system to perform the method including: receiving, via a data receiver, the plurality of timed traces; storing, via a processor configured to execute instructions stored in a memory, the received plurality of timed traces into the memory; generating, via the processor, a partial order graph of time constraints between all of the plurality of timed traces; generating, via the processor, a transitive reduced partial order graph from the partial order graph, the transitive reduced partial order graph not including redundant time constraints within the partial order graph; and generating, via the processor, a timed partial order graph from the transitive reduced partial order graph, the timed partial order graph having a minimum number of clocks required to explain the time constraints between all of the plurality of timed traces.

In some embodiments of this aspect, the computer-readable instructions are capable of instructing the system to perform the method further including displaying, via a display, the timed partial order graph.

In some embodiments of this aspect, the computer-readable instructions are capable of instructing the system to perform the method further including: adding, via a user interface, a new timed trace to the plurality of timed traces; generating, via the processor, an updated partial order graph of updated time constraints between all of the plurality of timed traces and the new timed trace; generating, via the processor, an updated transitive reduced partial order graph from the updated partial order graph, the updated transitive reduced partial order graph not including redundant time constraints within the updated partial order graph; and generating, via the processor, an updated timed partial order graph from the updated transitive reduced partial order graph, the updated timed partial order graph having an updated minimum number of clocks required to explain the time constraints between all of the plurality of timed traces and the new timed trace.

In some embodiments of this aspect, the computer-readable instructions are capable of instructing the system to perform the method further including: modifying, via a user interface, a timed trace of the plurality of timed traces; generating, via the processor, an updated partial order graph of updated time constraints between all of the plurality of timed traces including the modified timed trace; generating, via the processor, an updated transitive reduced partial order graph from the updated partial order graph, the updated transitive reduced partial order graph not including redundant time constraints within the updated partial order graph; and generating, via the processor, an updated timed partial order graph from the updated transitive reduced partial order graph, the updated timed partial order graph having an updated minimum number of clocks required to explain the time constraints between all of the plurality of timed traces including the modified timed trace.

### BRIEF SUMMARY OF THE DRAWINGS

The accompanying drawings, which are incorporated in and form a part of the specification, illustrate and explain example embodiments. In the drawings:

FIG. 1A illustrates a portion of a related art partial order graph of a beginner player of a video game;

FIG. 1B illustrates a second portion of the related art partial order graph of FIG. 1A;

FIG. 2 illustrates another related art partial order graph of an expert player of a video game;

FIG. 3 illustrates timed traces for the workflow of a task of installing a window in an automobile in an assembly line;

FIG. 4 illustrates a method of generating a timed partial order (TPO) graph in accordance with aspects of the present disclosure;

FIG. 5 illustrates a TPO graph generator for executing the method of FIG. 4;

FIG. 6A illustrates a partial order graph of the workflow of FIG. 4;

FIG. 6B illustrates a transitive reduced partial order (TRPO) graph of the partial order graph of FIG. 6A;

FIG. 6C illustrates a TPO graph of the TRPO graph of FIG. 5B;

FIG. 7 illustrates an example method for minimizing clocks to generate a TOP graph in accordance with aspects of the present disclosure;

FIG. 8 illustrates an example method of removing redundant constraints in accordance with aspects of the present disclosure;

FIG. 9 illustrates a TPO graph and related time constraints;

FIG. 10 illustrates another TRPO graph and related time constraints;

FIG. 11 illustrates another TRPO graph and related time constraints;

FIG. 12A illustrates another TRPO graph and related time constraints;

FIG. 12B illustrates the TRPO graph of FIG. 12A with clock information;

FIG. 12C illustrates the TRPO graph of FIG. 12B with modified clock information in accordance with aspects of the present disclosure;

FIG. 13A illustrates a timing diagram of events;

FIG. 13B illustrates the timing diagram of FIG. 13A with renumbered clocks in accordance with aspects of the present disclosure;

FIG. 14A illustrates a portion of a TRPO graph of a beginner player of a video game in accordance with aspects of the present disclosure;

FIG. 14B illustrates a second portion of the TRPO graph of FIG. 14A; and

FIG. 15 illustrates a TRPO graph of an expert player of a video game in accordance with aspects of the present disclosure.

### DETAILED DESCRIPTION

A system in accordance with aspects of the present disclosure provides novel approach to learning automata (a spider-web-like structure model) as a task representation. More specifically, a task is learned as a “Timed Partial Order Graph” in which strict orders and no-order relations are expressed between sub-tasks along with time constraints. This model is very useful in a factory and other settings to represent important dependencies between events with time information. A system in accordance with aspects of the present disclosure provides a new approach that uses an efficient optimization method to estimate the structure and the time constraints of the Timed Partial Order Graph.

Event data with time stamps is collected from the factory line (called Timed Traces). From the timed traces, two-step processes are performed: 1) Partial Order Graph Identification and; 2) Timed Partial Order Graph Identification. The former correctly identifies the structure of the task as a Partial Order Graph, which is then reduced to a minimum graph using a well-known method called Transitive Reduction. Subsequently, given the timed traces and the structure, the time constraints that are “necessary” to explain the data are estimated. The approach first constructs time constraints between all pairs of events that are in the Partial Order Graph (before the reduction) and iteratively remove constraints that are redundant (which can be inferred from other constraints). This minimizes the number of “clocks” to explain the time constraints between a pair of events. The resulting output is a Timed Partial Order whose structure is always correct, and the estimated time constraints always accept the input traces (timed traces).

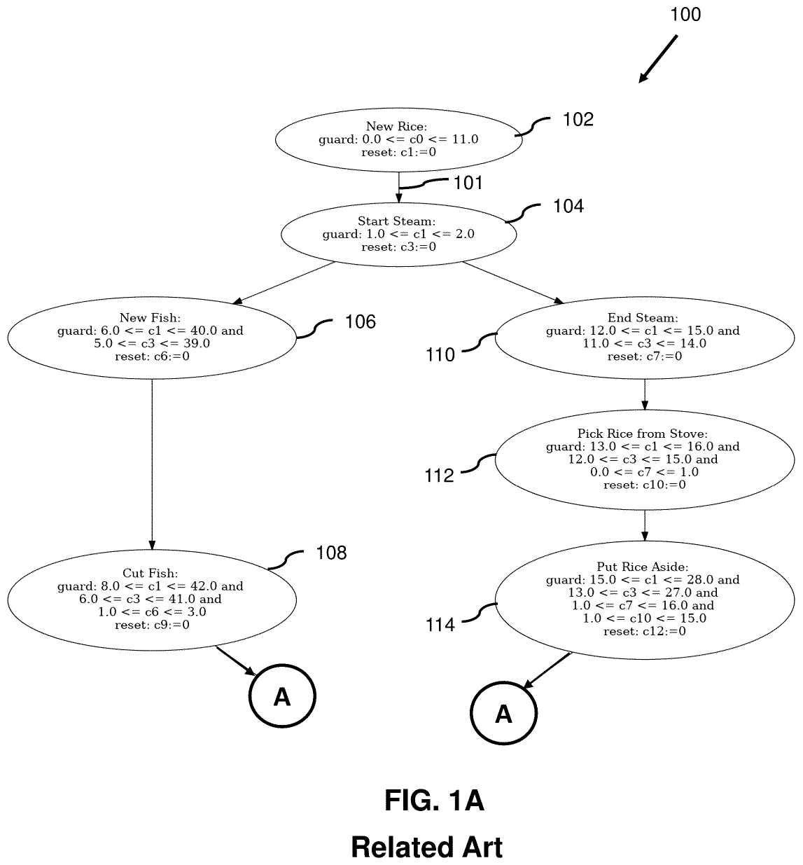

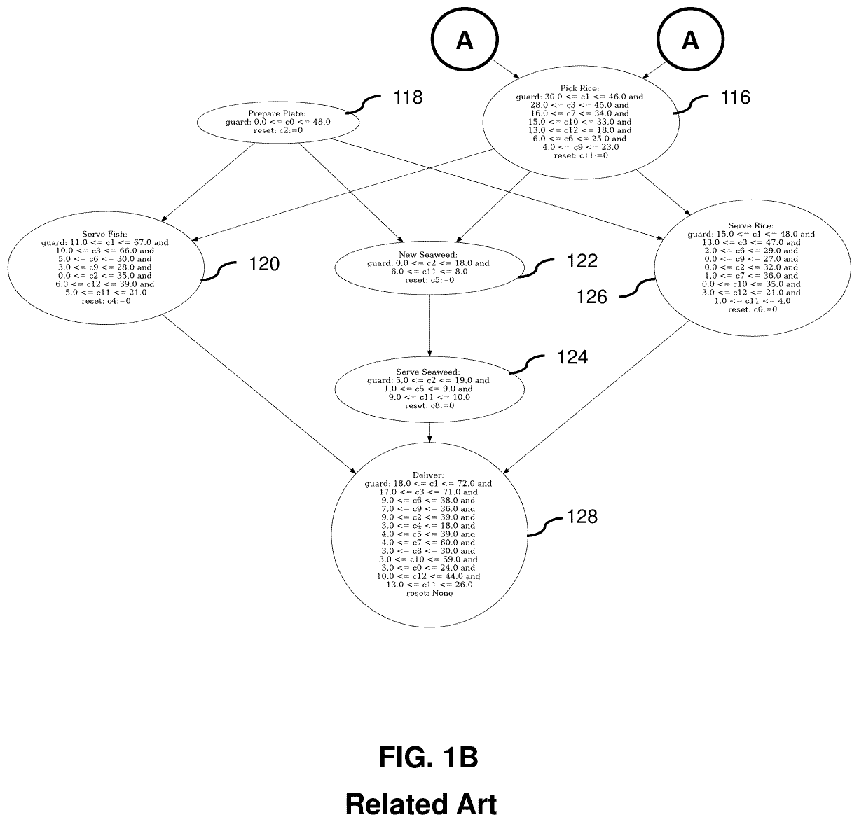

FIGS. 1A-B illustrate a related art transitive reduced partial order (TRPO) graph 100 of a beginner player of a video game. In this example, the video game is a cooking game, wherein the player must obtain ingredients, prepare meals with the ingredients, and deliver the prepared meals in a timely fashion.

As shown in FIG. 1A, TRPO graph 100 includes a plurality of events, 102, 104, 106, 108, 110, 112, 114, and a plurality of edges linking various events, a sample of which is indicated as edge 101.

In TRPO graph 100, an edge, such as edge 101, represents a “happens-before” time relationship, wherein the beginning of the arrow of the edge represents that an event occurs at a time before the head of the arrow of the edge. For example, edge 101 represents that event 102 occurs at a time before event 104.

Each event represents an action that the player must undertake. In this example: event 102 corresponds to the player obtaining rice; event 104 corresponds to the player starting to steam the rice; event 106 corresponds to the player obtaining a new piece of fish; event 108 corresponds to the player cutting the new piece of fish that was obtained in event 106; event 110 corresponds to the player ending the steaming of the rice from event 104; event 112 corresponds to the player retrieving the steamed rice from event 110 from the stove; event 114 corresponds to the player putting aside the retrieved rice from event 112.

FIG. 1B continues TRPO graph 100 with events 116, 118, 120, 122, 124, 126, and 128. As further shown in this example: event 116 corresponds to the player obtaining the rice that was set aside in event 114 as shown in FIG. 1A; event 118 corresponds to the player preparing a plate; event 120 corresponds to the player serving the fish; event 122 corresponds to the player obtaining new seaweed; event 124 corresponds to the player serving the seaweed obtained in event 122; event 126 corresponds to the player serving the rice; and event 128 corresponds to the player delivering the meal to the customer.

Each event in TRPO graph 100 includes clock data and constraints, wherein the constraints are indicated by the term “guard”. For example, event 102 in FIG. 1A includes a single constraint, wherein the guard is for an initial clock c0, such that the event of obtaining new rice is performed between 0.0 and 11.0 time units, i.e., 0.0≤c0≤11.0. Further, event 102 starts a new clock c1, i.e., c1=0.

Event 104, which occurs after event 102 as evidenced by edge 101, indicates that the event of starting steam occurs between 1.0 and 2.0 time units after c1 is started, i.e., 1.0≤c1≤2.0. Further, event 104 starts a new clock, c3, i.e., c3=0.

As the events transpire, some are a function of previous clocks, some start new clocks, and some are a combination of both. If an event includes a guard for a particular clock(s), or resets a particular clock, then any subsequent event that is tied thereto with a “happens-before” arrow may also reference those clocks.

For example, event 108 corresponding to the player cutting the new piece of fish that was obtained in event 106, has a guard that includes constraints on clocks c1, c3, and c6, wherein clock c1 is reset in event 102, clock c3 is reset in event 104, and clock c6 is reset in event 106. On the other hand, event 114 corresponding to the player putting aside the retrieved rice from event 112, has a guard that includes constraints on clocks c1, c3, c7, and c10, wherein clock c1 is reset in event 102, clock c3 is reset in event 104, clock c7 is reset in event 110, and clock c10 is reset in event 112.

Finally, as shown in FIG. 1B, event 128 corresponding to the player delivering the meal to the customer, has a guard that includes constraints on 13 different clocks. In particular, in this example, the player ultimately delivers the meal to the customer: between 3.0 and 20.0 time units after the start of clock c0, i.e., 3.0≤c0≤20.0; between 18.0 and 72.0 time units after the start of clock c1, i.e., 18.0≤c1≤72.0; between 9.0 and 39.0 time units after the start of clock c2, i.e., 9.0≤c2≤39.0; between 17.0 and 71.0 time units after the start of clock c3, i.e., 17.0≤c3≤71.0; between 3.0 and 18.0 time units after the start of clock c4, i.e., 3.0≤c4≤18.0; between 4.0 and 39.0 time units after the start of clock c5, i.e., 4.0≤c5≤39.0; between 9.0 and 38.0 time units after the start of clock c6, i.e., 9.0≤c6≤38.0; between 4.0 and 60.0 time units after the start of clock c7, i.e., 4.0≤c7≤60.0; between 3.0 and 30.0 time units after the start of clock c8, i.e., 3.0≤c8≤30.0; between 7.0 and 36.0 time units after the start of clock c9, i.e., 7.0≤c9≤36.0; between 3.0 and 59.0 time units after the start of clock c10, i.e., 3.0≤c10≤59.0; between 13.0 and 26.0 time units after the start of clock c11, i.e., 13.0≤c11≤26.0; and between 10.0 and 44.0 time units after the start of clock c12, i.e., 10.0≤c12≤44.0.

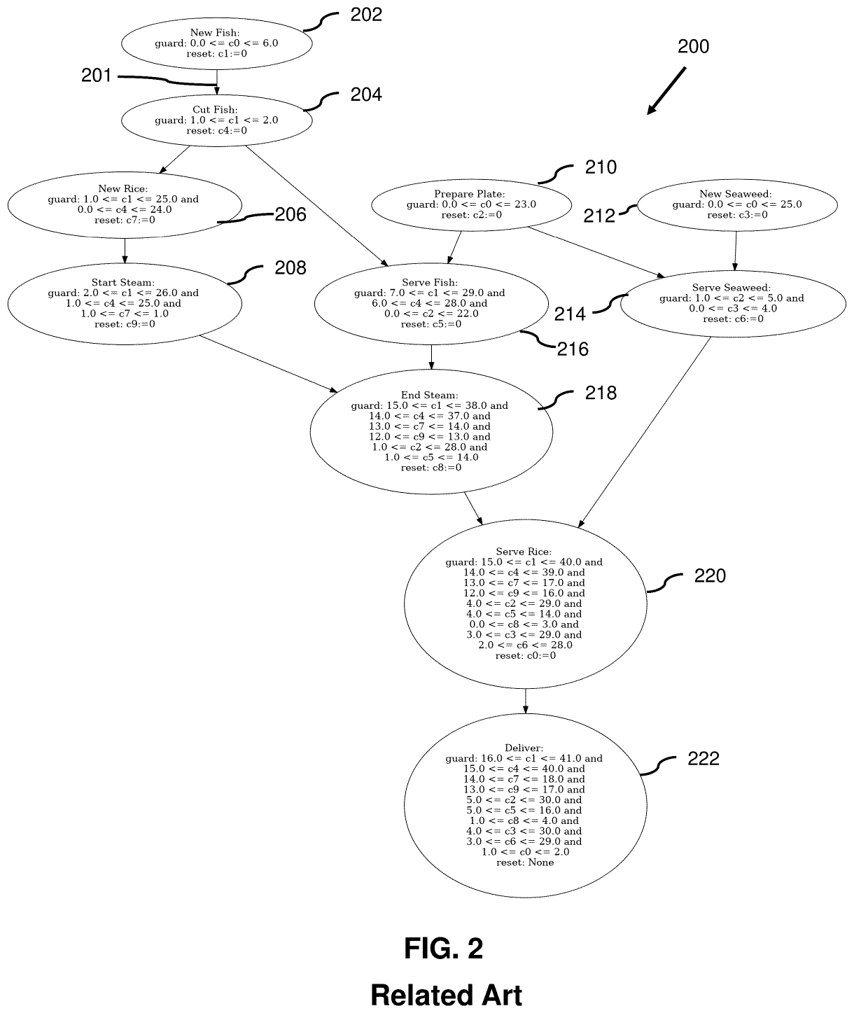

FIG. 2 illustrates a TRPO graph 200 of an expert player of the video game of FIGS. 1-2.

As shown in FIG. 2, TRPO graph 200 includes a plurality of events, 202, 204, 206, 208, 210, 212, 214, 216, 218, 220, and 222, and a plurality of edges linking various events, a sample of which is indicated as edge 201.

In this example: event 202 corresponds to the player obtaining a new piece of fish; event 204 corresponds to the player starting cutting the fish obtained from event 202; event 206 corresponds to the player obtaining new rice; event 208 corresponds to the player starting steam for the rice; event 210 corresponds to the player preparing a plate; event 212 corresponds to the player obtaining new seaweed; event 214 corresponds to the player serving the seaweed; event 216 corresponds to the player serving the fish that was cut in event 204; event 218 corresponds to the player ending the steam; event 220 corresponds to the player serving the rice; and event 222 corresponds to the player delivering the meal to the customer.

Each event in TRPO graph 200 includes clock data. For example, event 202 includes an initial clock c0, wherein the event of obtaining a new piece of fish is performed between 0.0 and 6.0 time units, i.e., 0.0≤c0≤6.0. Further, event 202 starts a new clock c1, i.e., c1=0.

Event 204, which occurs after event 202 as evidenced by edge 201, indicates that the event of cutting the fish occurs between 1.0 and 2.0 time units after c1 is started, i.e., 1.0≤c1≤2.0. Further, event 204 starts a new clock, c4, i.e., c4=0.

As the events transpire, some are a function of previous clocks, some start new clocks, and some are a combination of both. Finally, event 222 corresponding to the player delivering the meal to the customer, is a function of 10 different clocks. In particular, in this example, the player ultimately delivers the meal to the customer: between 1.0 and 2.0 time units after the start of clock c0, i.e., 1.0≤c0≤2.0; between 16.0 and 41.0 time units after the start of clock c1, i.e., 16.0≤c1≤41.0; between 5.0 and 30.0 time units after the start of clock c2, i.e., 5.0≤c2≤30.0; between 4.0 and 30.0 time units after the start of clock c3, i.e., 4.0≤c3≤30.0; between 15.0 and 40.0 time units after the start of clock c4, i.e., 15.0≤c4≤40.0; between 5.0 and 16.0 time units after the start of clock c5, i.e., 5.0≤c5≤16.0; between 3.0 and 29.0 time units after the start of clock c6, i.e., 3.0≤c6≤29.0; between 14.0 and 18.0 time units after the start of clock c7, i.e., 14.0≤c7≤18.0; between 1.0 and 4.0 time units after the start of clock c8, i.e., 1.0≤c8≤4.0; and between 13.0 and 17.0 time units after the start of clock c9, i.e., 13.0≤c9≤17.0.

While the TRPO graphs of FIG. 1-2 provide data related to playing a video game, the graphs provide too much information for a person to analyze.

What is needed is a system and method for reducing the complexity of a TRPO graph.

A system and method in accordance with the present disclosure reduces the complexity of a TRPO graph.

The purpose of a system and method in accordance with aspects of the present disclosure is to estimate tasks (task order and time constraints) from human data for: (1) easy interpretation of the task and training (e.g., new employee); (2) planning and training for robots in human-robot collaborative environments; (3) optimizing factory flexible cell manufacturing from the learned constraints; (4) optimizing pickup and deli very schedules for mobile robots in hospitals, warehouses, stores, etc. A system and method in accordance with aspects of the present disclosure focuses on learning the correct order of the task and the time constraints between each task.

Broadly speaking, the technology with which a system and method in accordance with aspects of the present disclosure generally relates can be classified as “Learning from Demonstration” regime in the machine learning community. Common approaches include policy learning to learn optimal actions that lead to task completion and inverse reinforcement learning to learn human intentions as a scalar value called “reward”. These differ from a system and method in accordance with aspects of the present disclosure in that they do not learn a “task” itself, but rather the actions to accomplish a task. More related technology is “specification” or “automata learning” where the objective is to learn an abstract representation (model) of a system. That is, the learning concerns focuses on what are the outcomes of each action. This field of work is called “workflow mining” and extensive studies have investigated the problem of finding the correct workflow. However, no prior method also aims to learn time constraints on the workflow.

A system and method in accordance with aspects of the present disclosure provides a novel approach to learning automata (a spider-web-like structure model) as a task representation. More specifically, a system and method in accordance with aspects of the present disclosure learns a task as a “timed partial order (TPO) graph” that expresses strict orders and no-order relations between sub-tasks along with time constraints. This model is very useful in a factory and other settings to represent important dependencies between events with time information. A system and method in accordance with aspects of the present disclosure uses an efficient optimization method to estimate the structure and the time constraints of the TPO graph.

In accordance with aspects of the present disclosure, consider the example situation provided merely for proposes of discussion, wherein event data with time stamps (called Timed Traces) is collected from a factory line. From the timed traces, a two-step algorithm is performed: first; a partial order graph identification is performed; and second, a TPO graph identification is performed. The partial order graph identification correctly identifies the structure of the task as a partial order graph. This is then reduced to a minimum graph using a well-known transitive reduction method. Subsequently, given the timed traces and the structure, the TPO graph identification estimates the time constraints that are “necessary” to explain the data. The approach first constructs time constraints between all pairs of events that are in the partial order graph (before the reduction) and iteratively removes constraints that are redundant (which can be inferred from other constraints). This minimizes the number of “clocks” to explain the time constraints between a pair of events. The resulting output is a TPO graph, whose structure is always correct, and the estimated time constraints always accept the input traces (timed traces). “Accept” here means all the traces have a path on this graph.

For the generated TPO graph: 1) the structure is always correct (if there is no noise in the data); 2) it accepts all input traces (the estimated time constraints respect the input data); 3) it is fast (less than 1s for 15 events); 4) it finds a minimal number of clocks to explain data so that it is easier for humans to interpret; and 5) it can also identify any number of independent tasks if they have no strict order relations between each task.

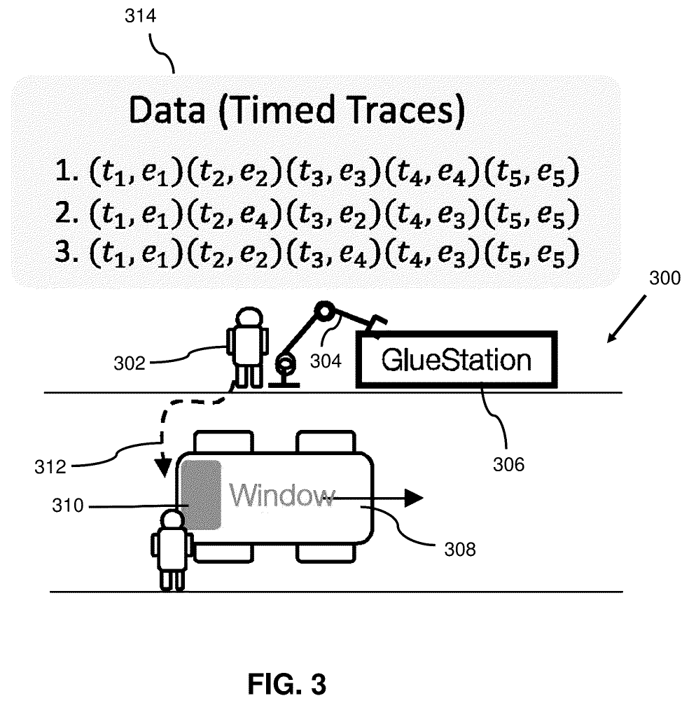

An example system and method for generating a TPO graph in accordance with aspects of the present disclosure will now be described in greater detail with reference to FIGS. 3-9.

FIG. 3 illustrates a plurality of timed traces 314 for a workflow 300 of a task of installing a window 310 in an automobile 308 in an assembly line. As shown in the figure, workflow 300 includes actions to be performed by a line worker 302 and by a robot 304 at a glue station 306. Line worker 302 may have to move along a path 312 to perform actions to complete the task of installing window 310.

In this example, let workflow 300 include events: e₁, wherein automobile 308 arrives at glue station 306 at a time t₁; e₂, wherein window 310 is set in a position to be placed on automobile 308 at a time t₂; e₃, wherein glue is pasted around an open area in automobile 308 to receive window 310 at a time t₃; e₄, wherein the area around window 310 is cleaned of dust at a time t₄; and e₅, wherein window 310 is set in place on automobile 308 at a time t₅.

Time traces data 314 includes a plurality of times traces to complete workflow 300, wherein each time trace includes an event, eᵢ, and a corresponding time stamp, which is a discrete time for which the corresponding event occurs. Using time traces data 314, an average of times for each respective event may be compiled. The average of time traces data 314 is used to create a timed partial order (TPO) graph in accordance with aspects of the present disclosure.

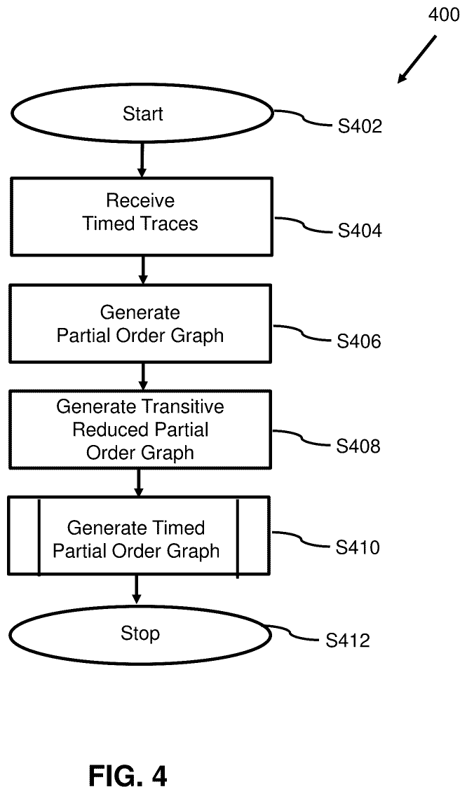

FIG. 4 illustrates a method 400 of generating a TPO graph in accordance with aspects of the present disclosure.

As shown in the figure, method 400 starts (S402), and timed traces are received (S404). For example, known system and method may record and store times traces for a particular task. Theses timed traces may be input to a TPO graph generator in accordance with aspects of the present disclosure.

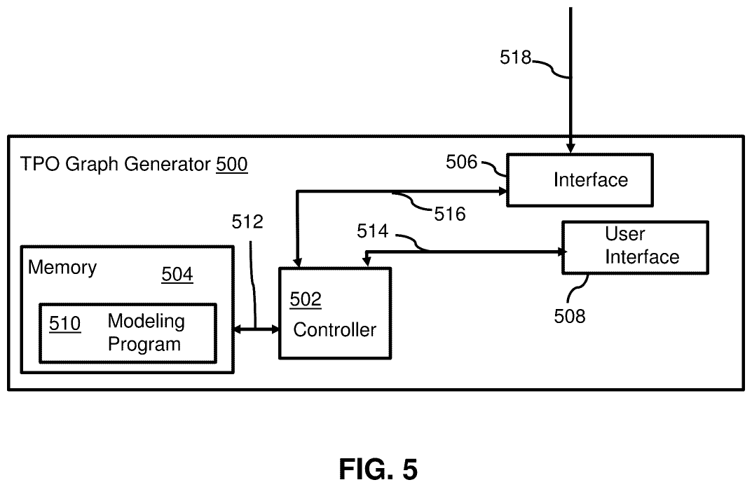

FIG. 5 illustrates a TPO graph generator 500 for executing the method of FIG. 4.

As shown in FIG. 5, TPO graph generator 500 includes a controller 502, a memory 504, an interface 506, and a user interface (UI) 508. Memory 504 includes data and instructions stored therein, including a modeling program 510.

In this example, controller 502, memory 504, interface 506, and UI 508 are illustrated as individual devices. However, in some embodiments, at least two of controller 502, memory 504, interface 506, and UI 508 may be combined as a unitary device. Further, in some embodiments, at least one of controller 502, memory 504, interface 506, and UI 508 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Controller 502 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of TPO graph generator 500 in accordance with the embodiments described in the present disclosure.

Memory 504 has modeling program 510 stored therein. As will be described in greater detail below, modeling program 510 has instructions stored therein to be executed by controller 502 to cause TPO graph generator 500 to: store a received plurality of timed traces for performing a task into memory 504; generate a partial order graph of time constraints between all pairs of the plurality of timed traces; generate a transitive reduced partial order graph from the partial order graph, the transitive reduced partial order graph not including redundant time constraints within the partial order graph; and generate a TPO graph from the transitive reduced partial order graph, the TPO graph having a minimum number of clocks required to explain the time constraints between all pairs of the plurality of timed traces.

In some embodiments, as will be described in greater detail below, modeling program 510 has instructions stored therein to be executed by controller 502 to cause TPO graph generator 500 to: generate an updated partial order graph of updated time constraints between all pairs of the plurality of timed traces and a new timed trace; generate an updated transitive reduced partial order graph from the updated partial order graph, the updated transitive reduced partial order graph not including redundant time constraints within the updated partial order graph; and generate an updated TPO graph from the updated transitive reduced partial order graph, the updated TPO graph having an updated minimum number of clocks required to explain the time constraints between all pairs of the plurality of timed traces and the new timed trace.

In some embodiments, as will be described in greater detail below, modeling program 510 has instructions stored therein to be executed by controller 502 to cause TPO graph generator 500 to: generate an updated partial order graph of updated time constraints between all pairs of the plurality of timed traces including a modified timed trace; generate an updated transitive reduced partial order graph from the updated partial order graph, the updated transitive reduced partial order graph not including redundant time constraints within the updated partial order graph; and generate an updated TPO graph from the updated transitive reduced partial order graph, the updated TPO graph having an updated minimum number of clocks required to explain the time constraints between all pairs of the plurality of timed traces including the modified timed trace.

UI 508 may be any device or system that is operable to enable a user to access and control controller 502. UI 508 may include one or more layers including a human-machine interface (HMI) machines with physical input hardware such a keyboards, mice, game pads and output hardware such as computer monitors, speakers, and printers. Additional UI layers in UI 508 may interact with one or more human senses, including: tactile UI (touch), visual UI (sight), and auditory UI (sound).

Interface 506 can include one or more connectors, such as RF connectors, or Ethernet connectors, and/or wireless communication circuitry, such as 5G circuitry and one or more antennas.

Controller 502 is configured to communicate with memory 504 via a communication channel 512, to communicate with UI 508 via a communication channel 514, and to communicate with interface 506 via a communication channel 516.

In operation, in some embodiments, interface 506 receives timed traces from an outside source (not shown). For example, suppose a line supervisor has recorded a plurality of timed traces into a hand-held tablet, while monitoring a worker at the glue station for workflow 300 discussed above with reference to FIG. 3. In such a situation, the hand-held tablet may download the timed traces to interface 506 via communication channel 518. Interface 506 may then provide these timed traces to controller 502 via communication channel 516. Controller 502 may execute instructions in modeling program 510 to cause controller 502 to store the timed traces in memory 504.

In other embodiments a user may directly input timed traces via UI 508. For example, suppose a line supervisor records timed traces, while monitoring a worker at the glue station for workflow 300 discussed above with reference to FIG. 3. In such a situation, the supervisor may enter the timed trace into TPO graph generator 500 via UI 508. UI 508 may then provide this timed trace to controller 502 via communication channel 514. Controller 502 may execute instructions in modeling program 510 to cause controller 502 to store the timed trace in memory 504. This process may be repeated until all the timed traces that are recorded are stored into memory 504.

Returning to FIG. 4, after the timed traces are received (S404), a partial order graph is generated (S406). For example, as shown in FIG. 5, controller 502 may execute instructions in modeling program 510 to cause TPO graph generator 500 to generate a partial order graph based on the timed traces in memory 504 by known methods.

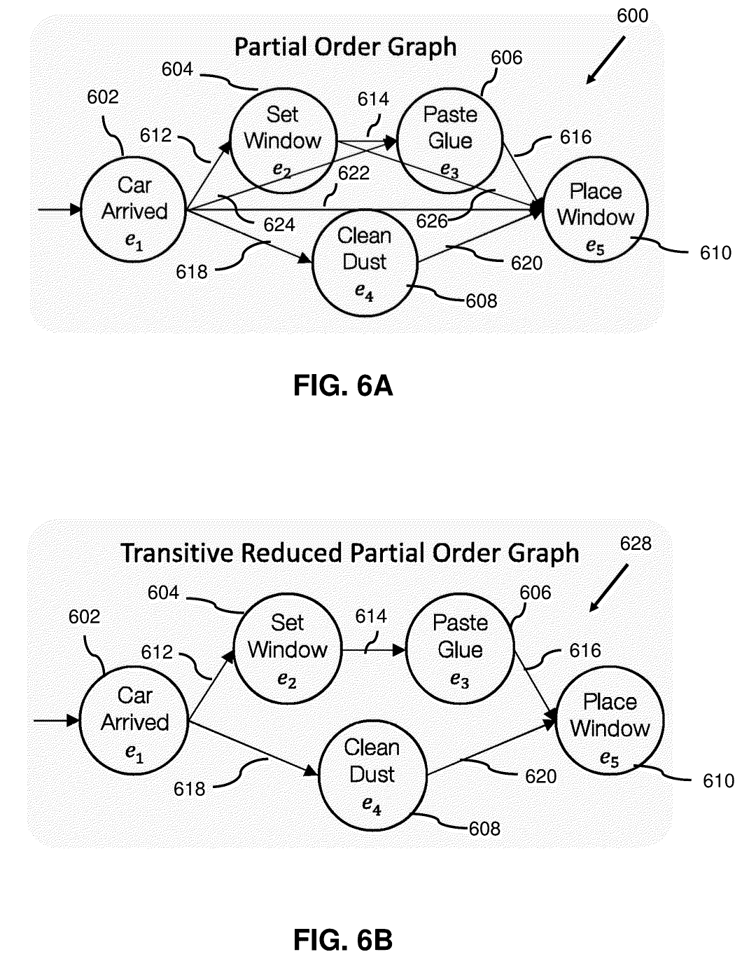

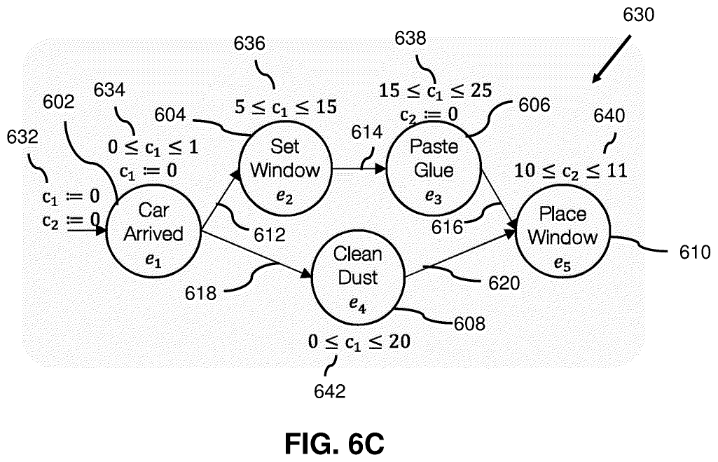

FIG. 6A illustrates a partial order graph 600 of the workflow 200 of FIG. 2.

As shown in FIG. 6A, partial order graph 600 includes events 602, 604, 606, 608 and 610, and edges 612, 614, 616, 618, 620, 622, 624, and 626.

In this example: event 602 corresponds to event e₁, wherein automobile 308 arrives at glue station 306 at a time t₁; event 604 corresponds to e₂, wherein window 310 is set in a position to be placed on automobile 308 at a time t₂; event 606 corresponds to event e₃, wherein glue is pasted around an open area in automobile 308 to receive window 310 at a time t₃; event 608 corresponds to e₄, wherein the area around window 310 is cleaned of dust at a time t₄; and event 610 corresponds to e₅, wherein window 310 is set in place on automobile 308 at a time t₅.

In this example, event 602 “happens-before” events 604 and 608, as evidenced by edges 612 and 618, respectively. As such, events 604 and 608 are temporal functions of event 602. Each of event 602 and event 604 “happens-before” event 606, as evidenced by edges 614, 624, and 612. Event 602 “happens-before” event 608, as evidenced by edge 618. Further, each of events 602, 604, 606, and 608 “happens-before” event 610, as evidenced by edges 622, 626, 616, 620, respectively.

Returning to FIG. 4, after the partial order graph is generated (S406), a transitive reduced partial order graph is generated (S408). For example, as shown in FIG. 5, controller 502 will execute instructions in modeling program 510 to cause TPO graph generator 500 to remove redundant edges in the partial order graph.

FIG. 6B illustrates a transitive reduced partial order graph 628 of partial order graph 600 of FIG. 6A. As shown in FIG. 6B, transitive reduced partial order graph 628 differs from partial order graph 600 of FIG. 6A in that transitive reduced partial order graph 628 does not include redundant edges 622, 624, or 626. In particular, edge 622 of partial order graph 600 is redundant because it is similarly captured by the combination of edge 612 and edge 614. Similarly, edge 626 of partial order graph 600 is redundant because it is similarly experienced by the combination of edge 614 and edge 618. Further, edge 622 of partial order graph 600 is redundant because it is similarly experienced by the combination of edge 618 and 620 or by the combination of edge 612, 614, and 616.

Returning to FIG. 4, after the transitive reduced partial order graph is generated (S408), a TPO graph is generated (S410). For example, as shown in FIG. 5, controller 502 will execute instructions in modeling program 510 to cause TPO graph generator 500 to generate a TPO graph in accordance with aspects of the present disclosure.

FIG. 6C illustrates a TPO graph 630 of transitive reduced partial order graph 628 of FIG. 6B. As shown in FIG. 6C, TPO graph 630 is similar to transitive reduced partial order graph 628 of FIG. 6B, but further includes time constraints for each event. In particular, as shown in FIG. 6C, event 602 includes indications of a first clock, c1, being initialized at 632. Further, event 602 should occur between 0 and 1 time units of the first clock. Before starting event 602, the main clock is initialized/reset. Then at event 606, the second clock is reset. This is because, as shown in event 610, after glue is applied in event 606, at least 10 seconds should pass before placing the window.

Event 604 will occur between 5 and 15 time units of the first clock, whereas event 606 will occur between 15 and 25 time units of the first clock. Additionally, a second clock, c₂ is initialized at event 606.

Event 608 will occur between 0 and 20 time units of the first clock.

Event 610 will occur between 10 and 11 time units after the second clock, c2, is initialized. It should be noted that in accordance with aspects of the present disclosure, we the optimal representation is not always provides. An object of generating a TPO graph in accordance with aspects of the present disclosure is to minimize the number of clocks. However, this does not guarantee absolute minimal representations. TPO graph 630 shows one possible representation that captures the dataset.

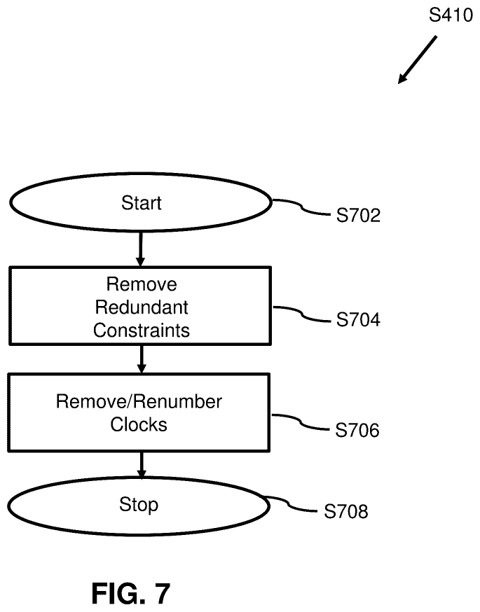

FIG. 7 illustrates an expanded view of the process of generating a TPO graph in accordance with aspects of the present disclosure.

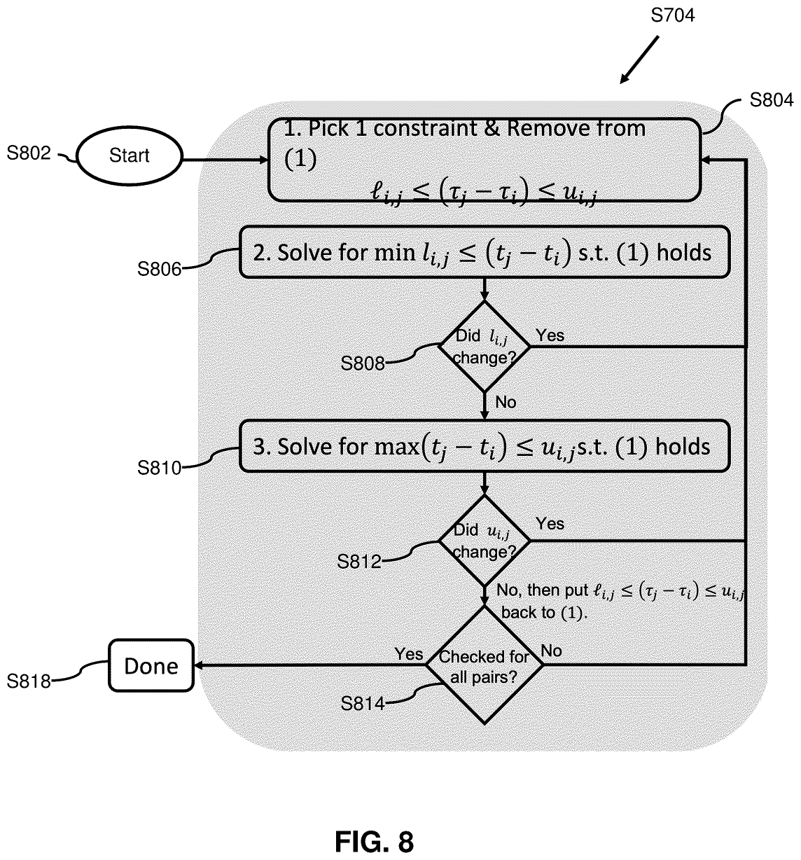

As shown in FIG. 7, the process (S410) starts (S702) and redundant constraints are removed (S704). For example, as shown in FIG. 5, controller 502 will execute instructions in modeling program 510 to cause TPO graph generator 500 to remove redundant constraints. This will be described in greater detail with reference to FIG. 8.

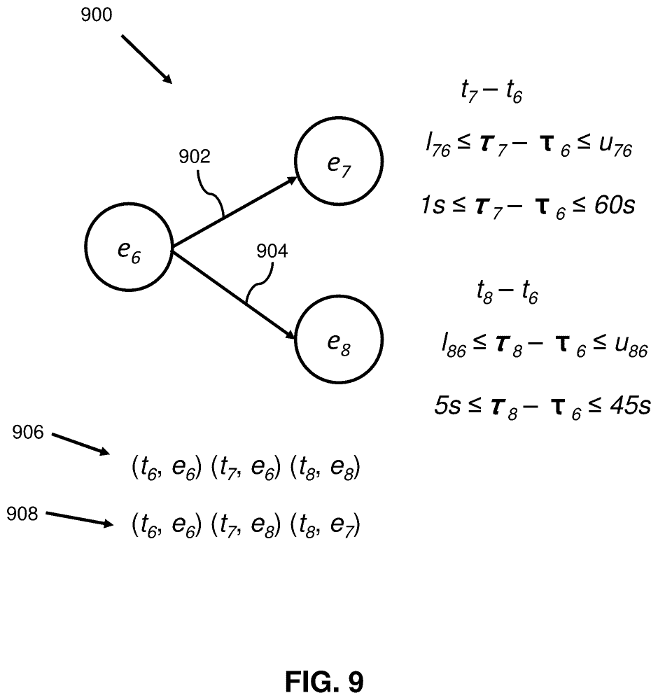

FIG. 8 illustrates an example method of removing redundant constraints (S704) in accordance with aspects of the present disclosure. As shown in the figure, the method starts (S802) and a constraint is chosen and removed. For example, as shown in FIG. 5, controller 502 will execute instructions in modeling program 510 to cause TPO graph generator 500 choose a constraint. This will be described in greater detail with reference to FIG. 9.

FIG. 9 illustrates a TRPO graph 900 and related time constraints. As shown in the figure, TRPO graph 900 includes an event e₆, an event e₇, and an event e₈. Event e₇ occurs after event e₆ as indicated by an edge 902, whereas event e₈ occurs after event e₆ as indicated by an edge 904. A timed trace 906 describes one instance of a performance of a task corresponding to TRPO graph 900, whereas a timed trace 908 describes a second instance of a performance of a tack corresponding to TRPO graph 900.

The difference in time between event e₇ and e₆ is represented as the time of event e₇ minus the time of event e₆, i.e., t₇−t₆. The values of all the time traces at time t₇ can be replaced with a variable τ₇ and the values of all the time traces at time to can be replaced with a variable τ₆. As all the time traces are included, one time trace will have a smallest different in time between event e₇ and event e₆, such that a difference between τ₇ and τ₆ will have a lower bound, l₇₆, i.e., l₇₆≤τ₇−τ₆. Further, another time trace will have a largest different in time between event e₇ and event e₆, such that a difference between τ₇ and τ₆ will have an upper bound, U₇₆, i.e., τ₇−τ₆≤U₇₆. This bounded relationship, l₇₆≤τ₇−τ₆≤U₇₆, describes edge 902 and is a constraint on event e₇. For purposes of discussion only, let the lower bound, l₇₆, be 1s and let the upper bound, U₇₆, be 60S, such that the constraint on event e₇ is 1s≤τ₇−τ₆≤60s.

Similarly, the difference in time between event e₈ and e₆ is represented as the time of e₈ minus the time of e₆, i.e., t₈-t₆. The values of all the time traces at time t₈ can be replaced with a variable τ₈. As all the time traces are included, one time trace will have a smallest different in time between event e₈ and event e₆, such that a difference between τ₈ and τ₆ will have a lower bound, l₈₆, i.e., l₈₆≤τ₈−τ₆. Further, another time trace will have a largest different in time between event e₈ and event e₆, such that a difference between τ₈ and τ₆ will have an upper bound, U₈₆, i.e., τ₈-τ₆≤U₈₆. This bounded relationship, l₈₆≤τ₈−τ₆≤U₈₆, describes edge 904 and is a constraint on event e₈. For purposes of discussion only, let the lower bound, l₈₆, be 5s and let the upper bound, U₈₆, be 60S, such that the constraint on event e₇ is 5s≤τ₈−τ₆≤60s.

Any TRPO may be derived to include constraints for each event in a manner discussed above with reference to FIG. 9 in accordance with aspects of the present disclosure. Further, some events may have multiple constraints derived from relationships to multiple previous events, respectively. If an event has more than one constraint, returning to FIG. 5, controller 502 will execute instructions in modeling program 510 to cause TPO graph generator 500 choose a constraint within that event. In some embodiments, TPO graph generator 500 may choose a constraint by a nearest, a distant, a random, or a sound algorithm. In a nearest algorithm, constraints tⱼ−tᵢ are considered in increasing order of the number of intermediate events between event eᵢ and event eⱼ, i.e, |{eₖ|eᵢ<eₖ<eⱼ}|. In a distant algorithm, constraints tⱼ−tᵢ are considered in decreasing order of the number of intermediate events between event eᵢ and event eⱼ. In a random algorithm, constraints are considered in a randomized order. In a sound algorithm, the algorithm starts from the last node, checks for all time constraints tⱼ−tᵢ [symbol] a that are dependent on tᵢ. If all of the time constraints are redundant, then all the time constraints are removed. Else, if any of the time constraints are required, all the time constraints are retained. This is because the clock at node i always be required.

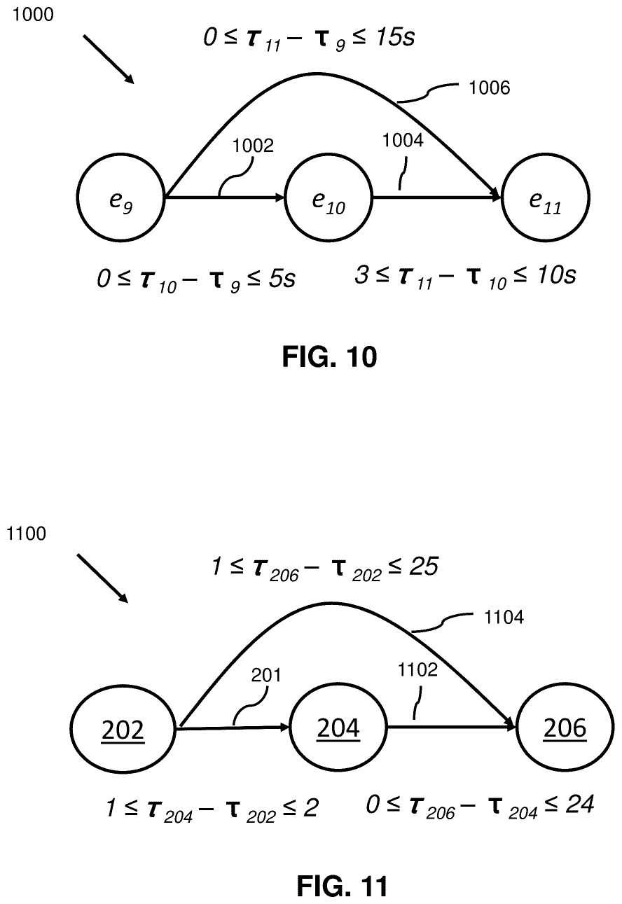

Returning to FIG. 8, once a constraint, of an event that has multiple constraints, is chosen (S804), then TPO graph generator 500 determines whether the chosen constraint includes a minimum lower bound (S806). This will be described in greater detail with reference to FIGS. 10-11.

FIG. 10 illustrates a TRPO graph 1000. As shown in the figure, TRPO graph 1000 includes an event e₉, an event e₁₀, and an event e₁₁. Event e₁₀ occurs after event e₉ as evidenced by an edge 1002. Event e₁₀ has a constraint of 0s≤τ₁₀−τ₉≤5s. Event e₁₁ occurs after event e₁₀ as evidenced by an edge 1004. Event e₁₁ has a constraint of 3s≤τ₁₁−τ₁₀≤10s. Event e₁₁ additionally occurs after event e₉ as evidenced by an edge 1006. Event e₁₁ therefore has an additional constraint of 0≤τ₁₁−τ₉≤15s. It should be noted that edge 1006 is not a redundant edge. Edge 1006 allows a transition within a three (3) second difference. The edge 1002 and the edge 1004 do not allow that. Specifically, edge 1004 requires at least a three (3) second difference.

In this example, event e₁₁ is the only event with multiple constraints. Consider the constraint of event e₁₁, 0s≤τ₁₁−τ₉≤15s. The lower bound is 0s, which is a minimum of the two constraints of event e₁₁. Therefore, if this constraint is removed from event e₁₁, then the minimum lower bound of the constraints would now be 3s, which is the lower bound of the other constraint of e₁₁, 3s≤τ₁₁−τ₁₀≤10s.

Returning to FIG. 8, if the removal of the constraint changes the lower bound of all the remaining constrains in the event, (Yes at S808), then that constraint cannot be removed. In this case, the constraint of 0s≤τ₁₁−τ₉≤15s cannot be removed from event e₁₁. Therefore, another constraint of the event is chosen (return to S804).

In this example the other constraint of event e₁₁ to be considered is 3s≤τ₁₁−τ₁₀≤10s. The minimum for event e₁₁ (S806) was previously determined to be 0s, as the constraint 0s≤τ₁₁−τ₉≤15s, has the minimum lower bound of 0s. Therefore, if the constraint 3s≤τ₁₁−τ₁₀≤10s is removed from event e₁₁, it would not change the lower bound of all the remaining constraints in the event, (No at S808).

At this point, the maximum upper bound of the constraints of event e₁₁ is determined (S810). In this example, the maximum upper bound is 15s, from the constraint 0s≤τ₁₁−τ₉≤15s. It is then determined whether if by removing the constraint under consideration will change the maximum upper bound (S812). If the removal of the constraint under consideration will change the maximum upper bound (Yes at S812), then the constraint under consideration cannot be removed and a new constraint is chosen (return to S804). If the removal of the constraint under consideration will not change the maximum upper bound (No at S812), then the constraint under consideration is removed as being redundant.

In the present example, removing the constraint 3s≤τ₁₁−τ₁₀≤10s will not affect the maximum upper bound because the 10s upper bound of the constraint is less than the 15s maximum upper bound of event e₁₁.

It is then determined whether all constraints within the event have been chosen (S814). If all constraints within the event have not been chosen (No at S814), then the next constraint is chosen (return to S804). However, if all constraints within the event have been chosen (Yes at S814), then the process of removing redundant constraints (S704) stops (S818).

As another example, the process of removing redundant constraints will be performed on a section of TRPO graph 200. This will be described in greater detail with reference to FIG. 11.

FIG. 11 illustrates the section 1100 of TRPO graph 200 of FIG. 2 with related time constraints. As shown in FIG. 11, event 204 (cutting fish) occurs after event 202 (getting a new fish), as evidenced by edge 201. In this example, let event 204 have a constraint of 1s≤τ₂₀₄−τ₂₀₂≤2s. Event 206 (getting new rice) occurs after event 204 as evidenced by an edge 1002. In this example, let event 206 have a constraint of 0s≤τ₂₀₆−τ₂₀₄≤24s. Event 204 occurs after event 202, and event 206 occurs after event 204. Thus, event 206 must occur after event 202 as evidenced by an edge 1104. Edge 1104 is not needed to be explicitly represented, as it is implied. In this example, let event 206 have an additional constraint of 1≤τ₂₀₆−τ₂₀₂≤25s.

In this example, removing the constraint 0s≤τ₂₀₆−τ₂₀₄≤24s will not affect the maximum upper bound because the 24s upper bound of the constraint is less than the 25s maximum upper bound of event 206. Therefore, the constraint 0s≤τ₂₀₆−τ₂₀₄≤24s is removed from event 206 as being redundant. In particular, given that: edge 201 has the constraint 1s≤τ₂₀₄−T₂₀₂≤2s; and edge 1104 has the constraint 1≤τ₂₀₆−τ₂₀₂≤25s, then the constraint 0s≤τ₂₀₆−τ₂₀₄≤24s for edge 1102 is not needed.

Specifically, adding the constraint 0s≤τ₂₀₆−τ₂₀₄≤24s of edge 1102 to the constraint 1s≤τ₂₀₄−τ₂₀₂≤2s of edge 201 will result in a constraint of 1s≤τ₂₀₆−τ₂₀₄≤26s, which is more relaxed than the constraint of edge 1104. For this reason, the constraint 0s≤τ₂₀₆−τ₂₀₄≤24s of edge 1102 is dropped.

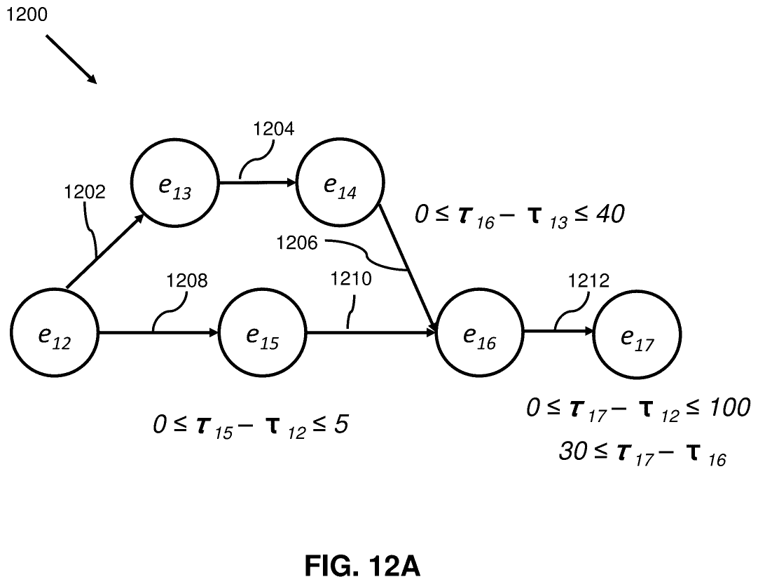

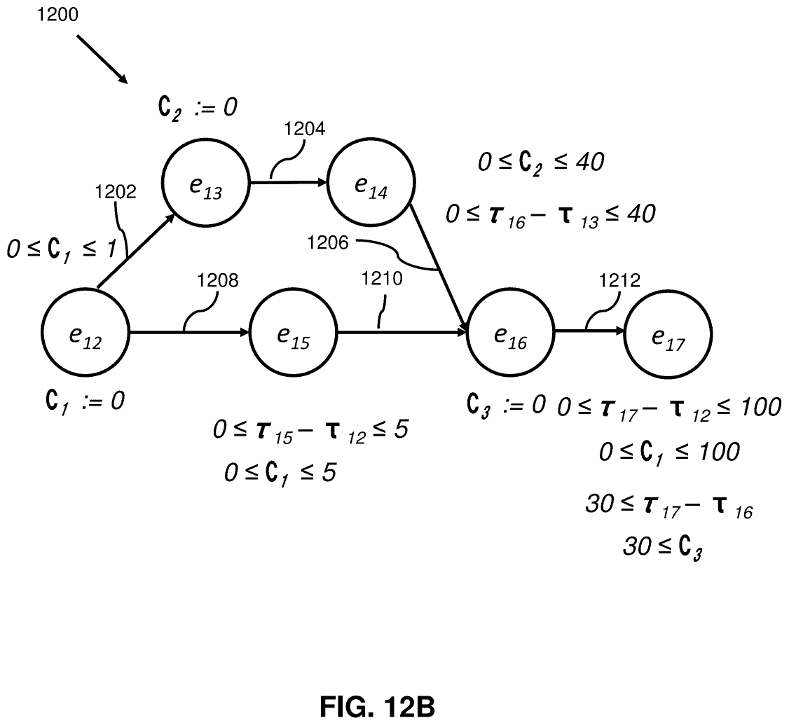

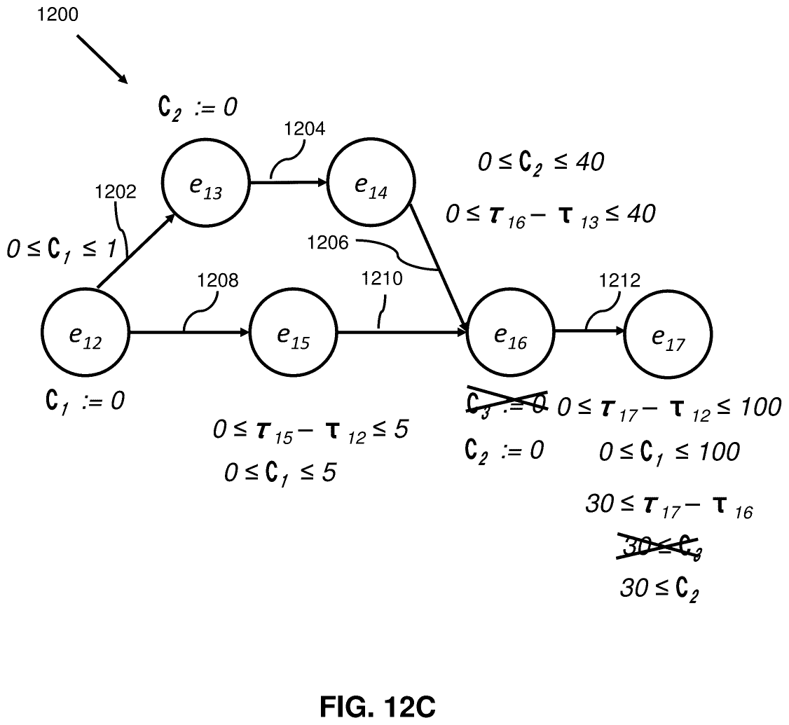

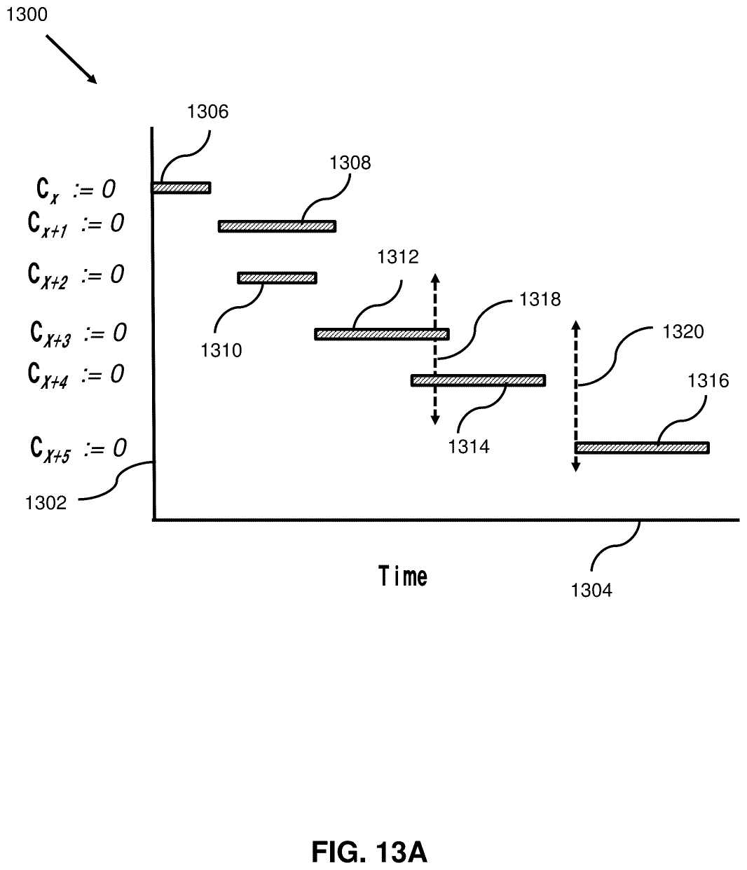

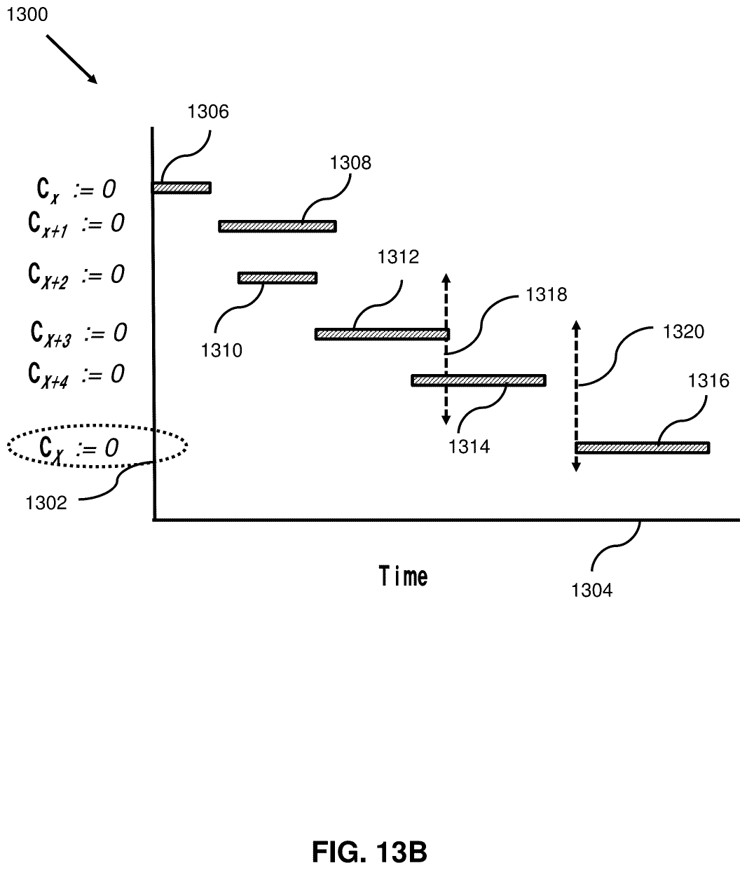

Returning to FIG. 7, after all redundant constraints have been removed (S704), then unnecessary clocks are removed and the remaining clocks are renumbered (S706). For example, as shown in FIG. 5, controller 502 will execute instructions in modeling program 510 to cause TPO graph generator 500 to remove unnecessary clocks and renumber the remaining clocks. This will be described in greater detail with reference to FIGS. 12A-13B.

FIG. 12A illustrates TRPO graph 1200 and related time constraints. As shown in the figure, TRPO graph 1200 includes an events e₁₂, e₁₃, e₁₄, e₁₅, e₁₆, and e₁₇, and edges 1202, 1204, 1206, 1208, 1210, and 1212.

Event e₁₃ occurs after event e₁₁ as evidenced by edge 1202. Event e₁₄ occurs after event e₁₃ as evidenced by edge 1204. Event e₁₆ occurs after event e₁₄ as evidenced by edge 1206. Event e₁₅ occurs after event e₁₂ as evidenced by edge 1208. Event e₁₆ occurs additionally after event e₁₅ as evidenced by edge 1210. Event e₁₇ occurs after event e₁₆ as evidenced by edge 1212.

Additionally shown in the figure are constraints for events e₁₅, e₁₆, and e₁₇. A partial order structure induces a transitive relation. Returning to TRPO graph 200 discussed above with reference to FIG. 2, any higher node is related to any lower node through transitive relation. For example, event 202 is related to event 206 through event 204. The same is the case for TRPO graph 1200 of FIG. 12A, wherein, for example, event e₁₃ can be related to event e₁₆ through event e₁₄.

The constraint for event e₁₅ is 0≤τ₁₅−τ₁₂≤5s. The constraint for event e₁₆ is 0≤τ₁₆−τ₁₃≤40s. The two constraint for event e₁₇ are 0≤τ₁₇−τ₁₂≤100s and 30≤τ₁₇−τ₁₆. It should be noted that, while not discussed, all redundant constraints have been removed from TRPO graph 1200 in a manner as discussed above with reference to FIGS. 8-11. Further, while all the events in TRPO graph 1200 have some constraints, only those illustrated for events e₁₅, e₁₆, and e₁₇ will be discussed for purposes of brevity.

Now that the constraints are shown, they will now be converted to clocks. This will be described in greater detail with reference to FIG. 12B.

FIG. 12B illustrates the TRPO graph 1200 with clock information. Starting with event e₁₅, a clock is needed. Therefore a clock C₁ is started (shown as “C₁: =0” in the figure) at the previous event, event e₁₁. Because event e₁₅ is dependent upon event e₁₂, the constraint 0≤τ₁₅−τ₁₂≤5s is replaced with the constraint in terms of the clock, i.e., 0≤C₁≤5s.

Similarly, for event e₁₆, the constraint 0≤τ₁₆−τ₁₃≤40s indicates that event e₁₆ is dependent upon event e₁₃. Because clock C₁ is in use, clock C₁ cannot be used for event e₁₆. Therefore a clock C₂ is started (shown as “C₂: =0” in the figure) at event e₁₃. Because event e₁₆ is dependent upon event e₁₃, the constraint 0≤τ₁₆−τ₁₃≤40s is replaced with the constraint in terms of the clock, i.e., 0≤C₂≤40s.

Event e₁₇ has two constraints: the constraint 0≤τ₁₇−τ₁₂≤100s, which indicates that event e₁₇ is dependent upon event e₁₂; and the constraint 30≤τ₁₇−τ₁₆, which indicates that event e₁₇ is dependent upon event e₁₆. Because event e₁₁ initiates clock C₁, clock C₁ can be used for the constraint 0≤τ₁₇−τ₁₂≤100s. As such, the constraint 0≤τ₁₇−τ₁₂≤100s is replaces with the restraint in terms of clock C₁, i.e., 0≤C₁≤100s. Because event e₁₇ is dependent upon event e₁₆, a new clock, clock C₃, is started (shown as “C₃: =0” in the figure) at event e₁₆. Clock C₃ can be used for the constraint 30≤τ₁₇−τ₁₆. As such, the constraint 30≤τ₁₇−τ₁₆ is replaced with the restraint in terms of clock C₃, i.e., 30≤C₃.

Therefore, as shown in FIG. 12B, TRPO graph 1200 can be described with three clocks. However, in accordance with aspects of the present disclosure, the number of clocks may be reduced.

FIG. 12C illustrates TRPO graph 1200 with modified clock information in accordance with aspects of the present disclosure.

As shown in the figure, clock C₂ is only used for the constraint of event e₁₆. After event e₁₆ is complete, clock C₂ is no longer used. Therefore, at event e₁₆, there is no need to start the new clock C₃ (indicated in the figure as clock C₃ being crossed out). Alternatively, clock C₂ may be reset (indicated in the figure as “C₂: =0”). Because clock C₃ has been replaced with clock C₂ at event e₁₆, the constraint 30≤τ₁₇−τ₁₆ at event e₁₇ is replaced with the restraint in terms of clock C₂, i.e., 30≤C₂.

In light of the above discussion of FIG. 12C, it is clear that TRPO graph 1200 is not described in terms of two clocks, as opposed to three clocks in FIG. 12B.

FIG. 13A illustrates a timing diagram 1300 of events. As shown in the figure, timing diagram 1300 includes a y-axis 1302 for integer clocks and an x-axis 1304 in time units. An event 1306 occurs at clock Cₓ: =0; an event 1308 occurs at clock Cₓ₊₁: =0; an event 1313 occurs at clock Cₓ₊₂=0; an event 1312 occurs at clock Cₓ₊₃=0; an event 1314 occurs at clock Cₓ₊₄=0; and an event 1316 occurs at clock Cₓ₊₅:=0.

In accordance with aspects of the present disclosure if an event overlaps in time with another event, for example event 1314 overlaps event 1312 as indicated by dashed arrow 1318, then a new clock is need for the overlapping event. However, if an event does not overlap with another event, for example event 1316 does not overlap any events as indicated by dashed arrow 1320, then a new clock is not needed.

FIG. 13B illustrates the timing diagram 1300 with renumbered clocks in accordance with aspects of the present disclosure. As shown in the figure, the clock for event 1316 has be changed to a previously used, but now unused, clock Cₓ. Therefore, the total number of clocks in timing diagram 1300 has been reduced and the last clock has been renumbered.

Returning to FIG. 7, after the unnecessary clocks are removed and the remaining clocks are renumbered (S706), process of generating the TPO (S410) stops (S708). Returning to FIG. 4, after the TPO graph is generated (S410), method 400 stops (S412).

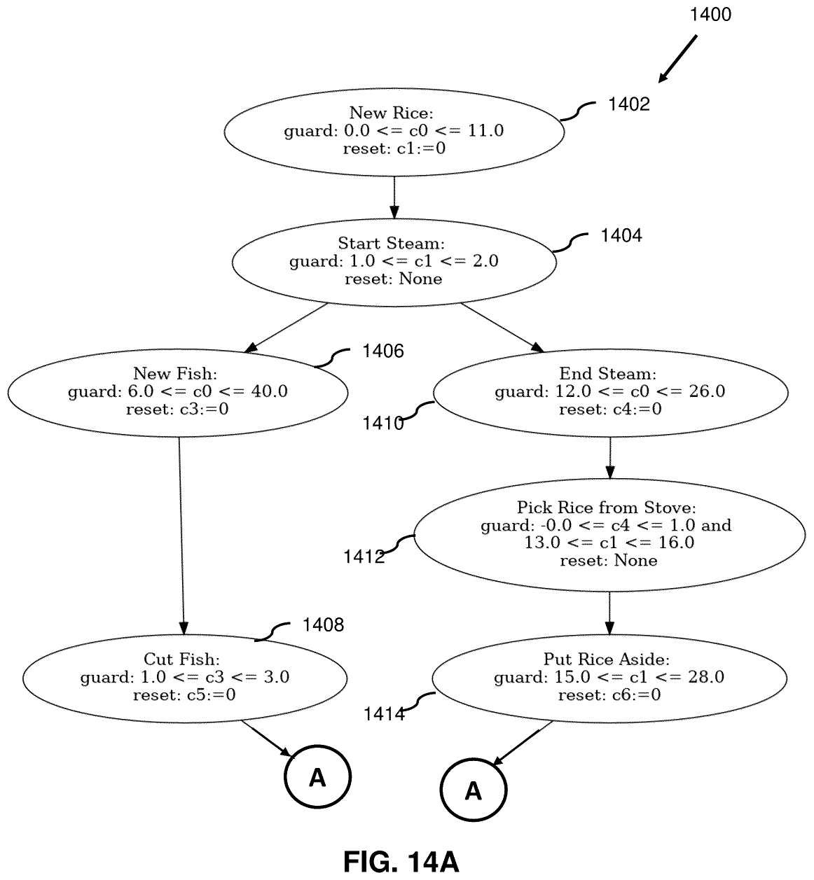

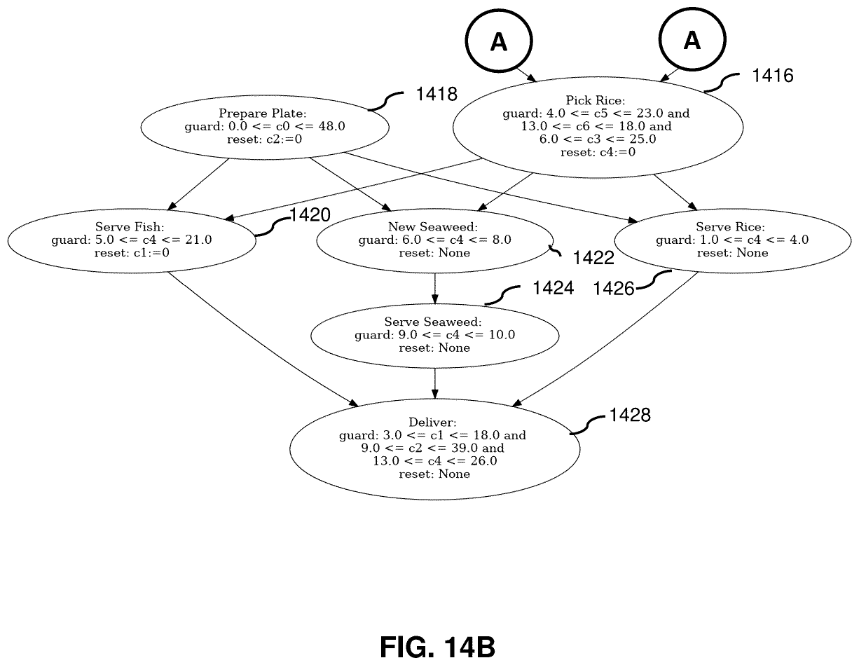

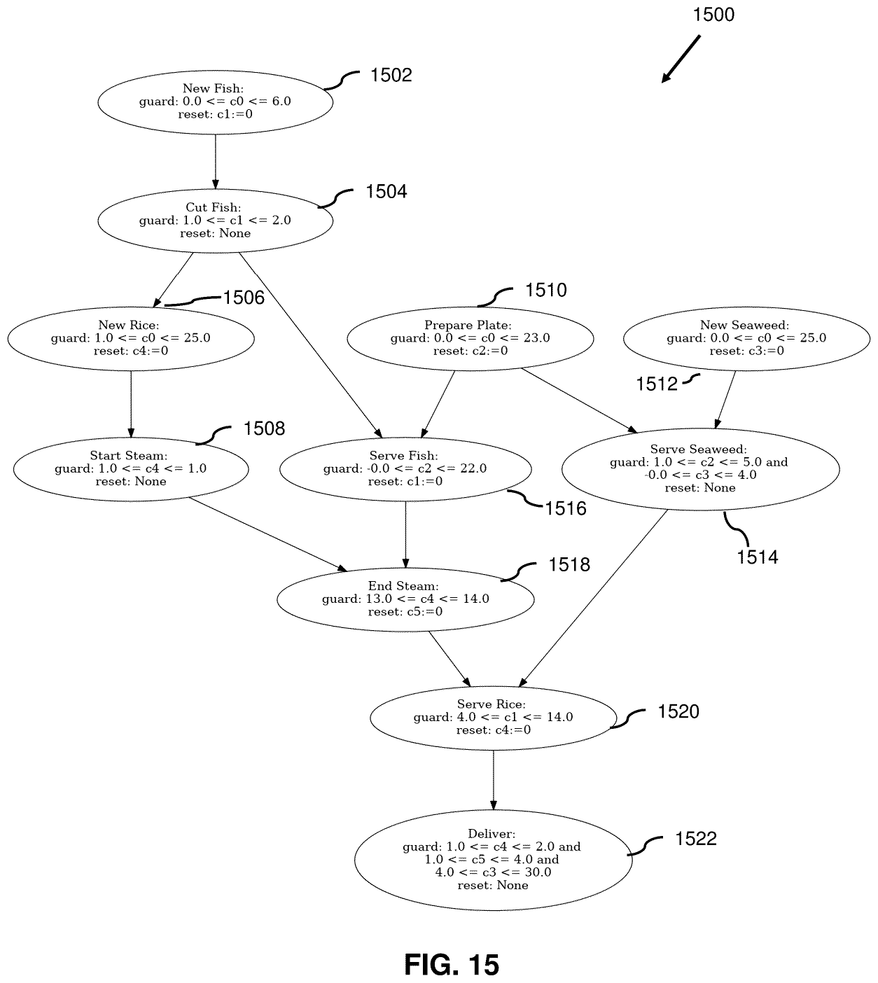

The benefits of a system and method in accordance with aspects of the present disclosure will now be further illustrated by comparing FIGS. 1A-B with FIGS. 14A-B, respectively, and by comparing FIG. 2 with FIG. 15.

FIG. 14A illustrates a portion of a TPO graph 1400 of a beginner player of a video game in accordance with aspects of the present disclosure. FIG. 14B illustrates a second portion of TPO graph 1400.

Events 1402, 1404, 1406, 1408, 1410, 1412, 1414, 1416, 1418, 1420, 1422, 1424, 1426, and 1428 of TPO graph 1400 correspond to events 102, 104, 106, 108, 110, 112, 114, 116, 118, 120, 122, 124, 126, and 128, respectively, of TRPO 100 discussed above with reference to FIGS. 1A-B. For purposes of brevity, a comparison of each pair of events will not be discussed here. However, one can easily note that event 128 of TRPO 100 includes 13 constraints and 13 clocks, whereas the corresponding event 1428 of TPO graph 1400 has only three constraints with 3 clocks. Further, as of event 1416, TPO graph 1400 has a maximum of 7 clocks, as evidenced by the constraint 13.0≤C6≤18.0.

FIG. 15 illustrates a TPO graph 1500 of an expert player of a video game in accordance with aspects of the present disclosure.

Events 1502, 1504, 1506, 1508, 1510, 1512, 1514, 1516, 1518, 1520, and 1522, of TPO graph 1500 correspond to events 202, 204, 206, 208, 210, 212, 214, 216, 218, 220, and 222, respectively, of TRPO 200 discussed above with reference to FIG. 2. For purposes of brevity, a comparison of each pair of events will not be discussed here. However, one can easily note that event 222 of TRPO 200 includes 10 constraints and 10 clocks, whereas the corresponding event 1522 of TPO graph 1500 has only three constraints with 3 clocks. Further, as of event 1522, TPO graph 1500 has a maximum of 5 clocks, as evidenced by the constraint 1.0≤C5≤4.0.

With respect to removing redundant constraints (see S704), consider event 1522. Each clock variable has two constraints: an upper and lower bound. In general, each event may have to satisfy timing constraints with respect to other events. For instance, event 1522 needs to happen 1 to 2s after event 1520 because clock C₄ is reset in event 1520. Further, event 1522 needs to occur 1 to 4 s after event 1518, and 4 to 30 s after event 1512. Analysis may show that the constraints on clock C₃ are always satisfied if the constraints on C₅ are satisfied and vice versa. But in general, time may need to be measured from multiple events that cannot be simplified or implied by one single clock variable.

In both the beginner's case of FIGS. 14A-B and the expert's case of FIG. 15, strict orders are correctly identified. For example, a fish must be cut before serving on a plate. The difference between the two is the order of the parallelizable tasks. Interestingly, the beginners start with cooking rice and then cutting fish, whereas the professionals start with cutting fish and then cooking rice. This is because beginners prepare dish one by one, and hence they must start with rice, which takes the longest time to prepare, whereas the professionals cook in a batch and the fish comes first in this strategy.

In terms of time constraints, strict constraints are imposed, such as (1) fish/seaweed must be cut/served immediately after a new object is taken out of the box (2) rice must be steamed for about 13-16 seconds in both figures. In contrast, a new object (plate, rice, and fish) can be taken out of the box at any time in the scene (with a large bound in c0). Furthermore, a time constraint between serving fish and rice (Serve Rice 4≤c1≤14) in FIG. 6 (bottom) specifies that parallel tasks must take similar times, so the dish can be delivered immediately after (Deliver 1≤c4≤2). This experiment shows that a TPO generating process in accordance with the present disclosure provides an interpretable representation for a task solely based on a small amount of data.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to enable others skilled in the art to best utilize the invention in various embodiments and with various modifications as are suited to the particular use contemplated. It is intended that the scope of the invention be defined by the claims appended hereto.

What is claimed is:

1. A system for use with a plurality of timed traces for performing a task, each of the plurality of timed traces includes a respective event data and a respective time data, said system comprising:
a data receiver configured to receive the plurality of timed traces;
a memory having instructions stored therein; and
a processor configured to execute the instructions stored in said memory to cause said system to:
store the received plurality of timed traces into said memory;
generate a partial order graph of time constraints between all of the plurality of timed traces;
generate a transitive reduced partial order graph from the partial order graph, the transitive reduced partial order graph not including redundant time constraints within the partial order graph; and
generate a timed partial order graph from the transitive reduced partial order graph, the timed partial order graph having a minimum number of clocks required to explain the time constraints between all of the plurality of timed traces.

2. The system of claim 1, further comprising a display configured to display the timed partial order graph.

3. The system of claim 1, further comprising:
a user interface configured to enable a user to add a new timed trace to the plurality of timed traces,
wherein said processor is configured to execute the instructions stored in said memory to additionally cause said system to:
generate an updated partial order graph of updated time constraints between all of the plurality of timed traces and the new timed trace;
generate an updated transitive reduced partial order graph from the updated partial order graph, the updated transitive reduced partial order graph not including redundant time constraints within the updated partial order graph; and
generate an updated timed partial order graph from the updated transitive reduced partial order graph, the updated timed partial order graph having an updated minimum number of clocks required to explain the time constraints between all of the plurality of timed traces and the new timed trace.

4. The system of claim 1, further comprising:
a user interface configured to enable a user to modify a timed trace of the plurality of timed traces,
wherein said processor is configured to execute the instructions stored in said memory to additionally cause said system to:
generate an updated partial order graph of updated time constraints between all of the plurality of timed traces including the modified timed trace;
generate an updated transitive reduced partial order graph from the updated partial order graph, the updated transitive reduced partial order graph not including redundant time constraints within the updated partial order graph; and
generate an updated timed partial order graph from the updated transitive reduced partial order graph, the updated timed partial order graph having an updated minimum number of clocks required to explain the time constraints between all of the plurality of timed traces including the modified timed trace.

5. The system of claim 1, wherein said processor is configured to execute the instructions stored in said memory to additionally cause said system to generate the timed partial order graph from the transitive reduced partial order graph by considering constraints tⱼ−tᵢ in an increasing order of the number of intermediate events between an event eᵢ and an event eⱼ.

6. The system of claim 1, wherein said processor is configured to execute the instructions stored in said memory to additionally cause said system to generate the timed partial order graph from the transitive reduced partial order graph by considering constraints tⱼ−tᵢ in a decreasing order of the number of intermediate events between an event eᵢ and an event eⱼ.

7. The system of claim 1, wherein said processor is configured to execute the instructions stored in said memory to additionally cause said system to generate the timed partial order graph from the transitive reduced partial order graph by considering constraints in a randomized order.

8. A method of using a plurality of timed traces for performing a task, each of the plurality of timed traces includes a respective event data and a respective time data, the method comprising:
receiving, via a data receiver, the plurality of timed traces;
storing, via a processor configured to execute instructions stored in a memory, the received plurality of timed traces into the memory;
generating, via the processor, a partial order graph of time constraints between all of the plurality of timed traces;
generating, via the processor, a transitive reduced partial order graph from the partial order graph, the transitive reduced partial order graph not including redundant time constraints within the partial order graph; and
generating, via the processor, a timed partial order graph from the transitive reduced partial order graph, the timed partial order graph having a minimum number of clocks required to explain the time constraints between all of the plurality of timed traces.

9. The method of claim 8, further comprising displaying, via a display, the timed partial order graph.

10. The method of claim 8, further comprising:
adding, via a user interface, a new timed trace to the plurality of timed traces;
generating, via the processor, an updated partial order graph of updated time constraints between all of the plurality of timed traces and the new timed trace;
generating, via the processor, an updated transitive reduced partial order graph from the updated partial order graph, the updated transitive reduced partial order graph not including redundant time constraints within the updated partial order graph; and
generating, via the processor, an updated timed partial order graph from the updated transitive reduced partial order graph, the updated timed partial order graph having an updated minimum number of clocks required to explain the time constraints between all of the plurality of timed traces and the new timed trace.

11. The method of claim 8, further comprising:
modifying, via a user interface, a timed trace of the plurality of timed traces;
generating, via the processor, an updated partial order graph of updated time constraints between all of the plurality of timed traces including the modified timed trace;
generating, via the processor, an updated transitive reduced partial order graph from the updated partial order graph, the updated transitive reduced partial order graph not including redundant time constraints within the updated partial order graph; and
generating, via the processor, an updated timed partial order graph from the updated transitive reduced partial order graph, the updated timed partial order graph having an updated minimum number of clocks required to explain the time constraints between all of the plurality of timed traces including the modified timed trace.

12. The method of claim 8, wherein said generating the timed partial order graph from the transitive reduced partial order graph comprises generating the timed partial order graph by considering constraints tⱼ−tᵢ in an increasing order of the number of intermediate events between an event eᵢ and an event eⱼ.

13. The method of claim 8, wherein said generating the timed partial order graph from the transitive reduced partial order graph comprises generating the timed partial order graph by considering constraints tⱼ−tᵢ in a decreasing order of the number of intermediate events between an event eᵢ and an event eⱼ.

14. The method of claim 8, wherein said generating the timed partial order graph from the transitive reduced partial order graph comprises generating the timed partial order graph by considering constraints in a randomized order.

15. A non-transitory, computer-readable media having computer-readable instructions stored thereon, the computer-readable instructions being capable of being read by a system for use with a plurality of timed traces for performing a task, each of the plurality of timed traces includes a respective event data and a respective time data, wherein the computer-readable instructions are capable of instructing the system to perform the method comprising:
receiving, via a data receiver, the plurality of timed traces;
storing, via a processor configured to execute instructions stored in a memory, the received plurality of timed traces into the memory;
generating, via the processor, a partial order graph of time constraints between all of the plurality of timed traces;
generating, via the processor, a transitive reduced partial order graph from the partial order graph, the transitive reduced partial order graph not including redundant time constraints within the partial order graph; and
generating, via the processor, a timed partial order graph from the transitive reduced partial order graph, the timed partial order graph having a minimum number of clocks required to explain the time constraints between all of the plurality of timed traces.

16. The non-transitory, computer-readable media of claim 15, wherein the computer-readable instructions are capable of instructing the system to perform the method further comprising displaying, via a display, the timed partial order graph.

17. The non-transitory, computer-readable media of claim 15, wherein the computer-readable instructions are capable of instructing the system to perform the method further comprising:
adding, via a user interface, a new timed trace to the plurality of timed traces;
generating, via the processor, an updated partial order graph of updated time constraints between all of the plurality of timed traces and the new timed trace;
generating, via the processor, an updated transitive reduced partial order graph from the updated partial order graph, the updated transitive reduced partial order graph not including redundant time constraints within the updated partial order graph; and
generating, via the processor, an updated timed partial order graph from the updated transitive reduced partial order graph, the updated timed partial order graph having an updated minimum number of clocks required to explain the time constraints between all of the plurality of timed traces and the new timed trace.

18. The non-transitory, computer-readable media of claim 15, wherein the computer-readable instructions are capable of instructing the system to perform the method further comprising:
modifying, via a user interface, a timed trace of the plurality of timed traces;
generating, via the processor, an updated partial order graph of updated time constraints between all of the plurality of timed traces including the modified timed trace;
generating, via the processor, an updated transitive reduced partial order graph from the updated partial order graph, the updated transitive reduced partial order graph not including redundant time constraints within the updated partial order graph; and
generating, via the processor, an updated timed partial order graph from the updated transitive reduced partial order graph, the updated timed partial order graph having an updated minimum number of clocks required to explain the time constraints between all of the plurality of timed traces including the modified timed trace.

19. The non-transitory, computer-readable media of claim 15, wherein the computer-readable instructions are capable of instructing the system to perform the method wherein said generating the timed partial order graph from the transitive reduced partial order graph comprises generating the timed partial order graph by considering constraints tⱼ−tᵢ in an increasing order of the number of intermediate events between an event eᵢ and an event eⱼ.

20. The non-transitory, computer-readable media of claim 15, wherein the computer-readable instructions are capable of instructing the system to perform the method wherein said generating the timed partial order graph from the transitive reduced partial order graph comprises generating the timed partial order graph by considering constraints tⱼ−tᵢ in a decreasing order of the number of intermediate events between an event eᵢ and an event eⱼ.
